(19) United States
(12) Patent Application Publication
(10) Pub. No.: US 2004/0153462 A1
(43) Pub. Date: Aug. 5, 2004

(54) Systems, methods, and computer program product for use in association with electronic documents

(76) Inventor: Steven J. Bardwell, Marshall, NC (US)

Correspondence Address: MCCARTER & ENGLISH LLP, CITYPLACE I, 185 ASYLUM STREET, HARTFORD, CT, 06103, US

(21) Appl. No.: 10/359,001

(22) Filed: Feb. 5, 2003

(51) Int. Cl. G06F 17/00

(52) U.S. Cl. 707/100

(57) ABSTRACT

Systems, Methods, and Computer Program Products for use in association with electronic documents are disclosed. According to one aspect, a computer implemented method includes providing a form overlay in a printer control format, the form overlay having at least one data tag field. The method further includes generating a PDF form in response to the form overlay, wherein the PDF form includes at least one PDF form field that is generated in response to the at least one data tag field of the form overlay. The one or more PDF form fields are modifiable when the PDF form is opened with a PDF reader, e.g., Adobe Acrobat Reader™. According to another aspect, a computer implemented method for responding to information submitted from a client to an intranet or internet server, the information being indicative of data entered into one or more PDF form fields of a PDF document, the method comprising: receiving the information submitted from the client; generating a data file having at least one data field in response to the information; generating a merged form in response to the data file and a form overlay in printer control format, the form overlay having at least one data tag field; and generating a PDF document in response to the merged form.

### TECHNICAL FIELD

The present disclosure relates to systems and methods for use in association with electronic documents.

### RELATED INFORMATION

As used herein, a blank form means a form that is at least partially blank in that one or more fields for data are unfilled or incomplete.

As used herein, a form overlay is a file in a printer control format that is a representation of a blank form.

With the advent of personal computer and various computer networks, including the Internet, it has become increasingly common to create and/or transmit documents (e.g., forms) in an electronic form. Such documents are sometimes referred to as electronic documents. Electronic documents typically include information content (such as text, graphics, and/or pictures) and may further include formatting information that controls how the information content is to be displayed. With recent advances in multimedia technology, some types of electronic documents can now also include sound, full motion video, and other multimedia content.

Authors, publishers and/or distributors (hereinafter collectively referred to as “publishers”) of electronic documents often seek to make their documents available to a large number of users. This raises a problem however, in that there are a great variety of hardware and software platforms current [symbol] each of which has its own idiosyncrasies. Thus, without appropriate m [symbol] asures, there is the possibility that the appearance of some electronic documents will vary depending on the particular hardware and software platform on which it is viewed. For example, the various software platforms such as DOS, Microsoft Windows®, and Macintosh® and other similar platforms all have their own display idiosyncrasies. Furthermore, the video monitors being used to view the electronic document can vary in size, resolution, and so on. In addition, each user or “reader” of the electronic document may have his or her own personal viewing preferences.

One solution to the above problem is to provide a “portable electronic document”, which can be viewed on a variety of platforms yet maintain the appearance substantially as intended by the publisher. One type of “portable electronic document” uses a format referred to as a Portable Document Format (hereinafter PDF).

PDF documents are often read and/or displayed using a computer program referred to as Adobe Acrobat™, available from Adobe Systems Incorporated, of San Jose, Calif. A version of this program is presently available from the Adobe Systems at no cost.

One drawback, however, is that this no cost version does not allow a user to manipulate (e.g., the text and/or graphics contained in) a PDF document and then store the PDF document as manipulated. Thus, in order to manipulate and store the text and/or graphics contained in a PDF document one must presently purchase an enhanced version of Adobe Acrobat™ or some other computer program. This creates a constraint on the availability of such editing technology, which in turn creates a constraint on the ability to create and/or use PDF documents that require any modification, such as, for example, data entry.

Forms are one type of electronic document often sought in a PDF format. Because forms usually call for data entry, PDF standards generally include PDF form fields, which can be included in a PDF document and filled out by a user (e.g., when the PDF document is opened using Adobe Acrobat™ or Adobe Acrobat Reader™).

Another drawback to PDF documents is that despite their availability, incorporating PDF form fields into a PDF document has been less convenient than desired, mainly because doing so has required the purchase of Adobe Acrobat™ or some other computer program. This is because as stated above, the no cost version of Adobe Acrobat™ (i.e., Adobe Acrobat Reader™) cannot be used to manipulate and then store a PDF document. In addition, although PDF documents may be produced by first creating a document using a word processor (e.g., Microsoft Word™ or WordPerfect®) or desktop publishing (e.g., Adobe PageMaker®, and Microsoft Publisher™) program, then converting the word or publishing document into a PCL, and finally converting the PCL file into a PDF document, such prior art conversion programs have not provided the capability to generate a PDF document with a PDF form field.

It is an object of some embodiments of the present invention to provide a system and/or method to help overcome one or more of the above described drawbacks of the prior art.

### SUMMARY

According to one aspect of the present invention, a computer implemented method includes providing a form overlay in a printer control format, the form overlay having at least one data tag field. The method further includes generating a PDF form in response to the form overlay, wherein the PDF form includes at least one PDF form field that is generated in response to the at least one data tag field of the form overlay. The one or more PDF form fields are modifiable when the PDF form is opened with a PDF reader, e.g., Adobe Acrobat Reader™.

In a currently preferred embodiment, the PDF document may also be printed, emailed, and/or sent over the Internet. In such embodiment, there is also the ability to gather client data electronically (e.g., through email or Web pages) and to print completed filled-in forms without the need for an enhanced version of Adobe Acrobat. Such embodiment provides a simple, easy-to-understand method for clients to provide prescribed data. From the client side, it presents the user with as an email attachment or Web page. The process of filling in the form is similar to that of typing in data on a hard-copy of the form. From the server side, the design of the PDF document can be accomplished using any word processing or graphics program that is able to produce a representation of the document in a PCL format.

According to another aspect of the present invention, a computer program product comprising: a computer readable storage medium; a computer program, stored on the computer readable storage medium, wherein the computer program, when executed by a computer, direct the computer to perform a method comprising: providing a form overlay in a printer control format, the form overlay having at least one data tag field; and generating a PDF form in response to the form overlay, wherein the PDF form includes at least one PDF form field that is generated in response to the at least one data tag field of the form overlay.

According to another aspect of the present invention, a system comprising: means for receiving a form overlay in a printer control format, the form overlay having at least one data tag field; and means for generating a PDF form in response to the form overlay, wherein the PDF form includes at least one PDF form field that is generated in response to the at least one data tag field of the form overlay.

According to another aspect of the present invention, a system comprising: a processor for providing a form overlay in a printer control format, the form overlay having at least one data tag field, and for generating a PDF form in response to the form overlay, wherein the PDF form includes at least one PDF form field that is generated in response to the at least one data tag field of the form overlay.

According to another aspect of the present invention, a method for universally modifying an electronic document comprising the acts of: creating an underlying electronic document having a selected one of a plurality of native formats; creating a blank form overlay, having a selected one of a plurality of native formats, based on the underlying electronic document by defining at least one data tag field; printing the blank form overlay to a file, on the computer readable storage medium, such that the act of printing causes the format of the blank form overlay to change from its selected one of a plurality of native formats to a PCL format; accessing the blank form overlay in PCL format on the computer readable storage medium; converting the format of the blank form overlay from PCL to IAPDF, such that each data tag field is converted to a data acro field; filling out the blank form overlay, by selectively adding data in the at least one data acro field, such that a completed electronic form is created; submitting the completed electronic form in a IAPDF format to the computer readable storage medium; and processing the completed electronic form on the computer readable storage medium via a script.

According to another aspect of the present invention, a computer implemented method for responding to information submitted from a client to an intranet or internet server, the information being indicative of data entered into one or more PDF form fields of a PDF document, the method comprising: receiving the information submitted from the client; generating a data file having at least one data field in response to the information; generating a merged form in response to the data file and a form overlay in printer control format, the form overlay having at least one data tag field; and generating a PDF document in response to the merged form.

According to another aspect of the present invention, a computer program product comprising: a computer readable storage medium; a computer program, stored on the computer readable storage medium, wherein the computer program, when executed by a computer, direct the computer to perform a method comprising: receiving the information submitted from the client; generating a data file having at least one data field in response to the information; generating a merged form in response to the data file and a form overlay in printer control format, the form overlay having at least one data tag field; and generating a PDF document in response to the merged form.

According to another aspect of the present invention, a system for responding to information submitted from a client to an intranet or internet server, the information being indicative of data entered into one or more PDF form fields of a PDF document, the system comprising: means for receiving the information submitted from the client; means for generating a data file having at least one data field in response to the information; means generating a merged form in response to the data file and a form overlay in printer control format, the form overlay having at least one data tag field; and means for generating a PDF document in response to the merged form.

According to another aspect of the present invention, a system for responding to information submitted from a client to an intranet or internet server, the information being indicative of data entered into one or more PDF form fields of a PDF document, the system comprising: a processor for receiving the information submitted from the client, generating a data file having at least one data field in response to the information, generating a merged form in response to the data file and a form overlay in printer control format, the form overlay having at least one data tag field; and generating a PDF document in response to the merged form.

Other advantages of one or more embodiments of one or more aspects of the present invention will become apparent in view of the following detailed description of preferred embodiments, claims, and accompanying drawings.

Notwithstanding the above potential advantages of the currently preferred embodiment, it should be recognized that there is no requirement that every embodiment of the present invention address the shortcomings of the prior art.

### BRIEF DESCRIPTION OF THE DRAWINGS

FIGS. 1A-1B are schematic block diagrams of a system in which documents may be created, filled and/or submitted in accordance with one embodiment of the present invention;

FIG. 2 is a flow diagram showing a process that may be used to generate a PDF document having one or more modifiable fields;

FIG. 3 is a representation of an electronic document having a plurality of data tag fields identifying information that is to be supplied by a user, in accordance with one embodiment of the present invention;

FIG. 4 is a representation of a PDF form generated by the system of FIG. 1 in response to the electronic document of FIG. 3;

FIG. 5 is a flowchart illustrating one embodiment for using the PDF document generated by the process of FIG. 2 to obtain information from a user;

FIG. 6 is a flowchart illustrating one embodiment for generating a new PDF document based on information received by the process of FIG. 5;

FIG. 7 is a representation of an electronic document that includes the information supplied by a user;

FIG. 8 is a flowchart illustrating the use of the above process for updating mailing information for customers; and

FIG. 9 is a flowchart illustrating one embodiment for detecting the presence of and/or parsing the data tag field(s) in the blank form shown in FIG. 3.

FIG. 10 is a block diagram showing a processor for generating a PDF form having one or more PDF form fields in response to a form overlay in printer control format having one or more data tag fields.

### DETAILED DESCRIPTION

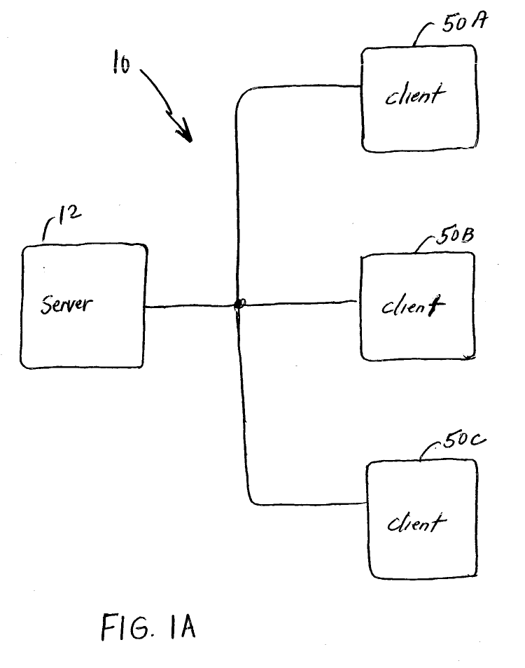

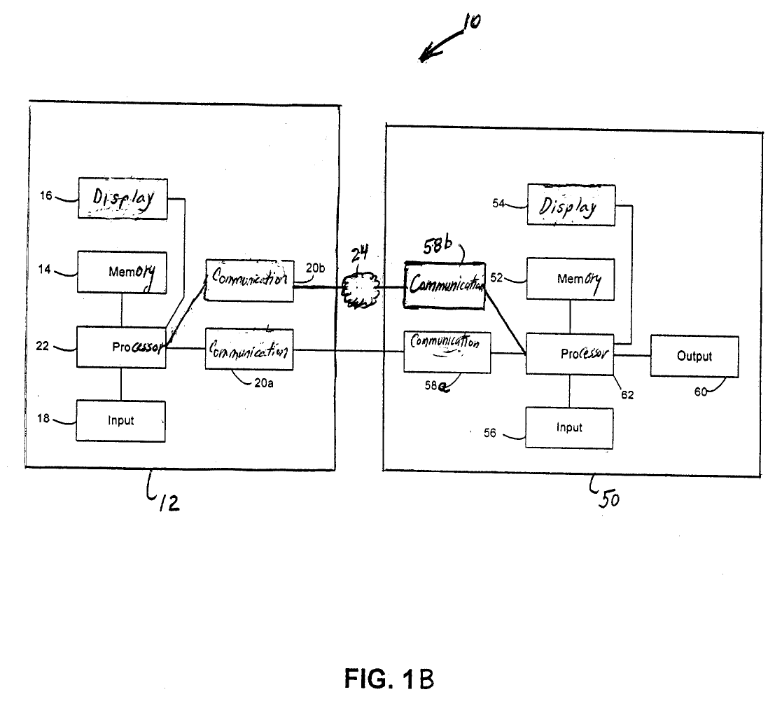

FIG. 1A is a schematic block diagram of a system 10 in which one embodiment of the present invention may be implemented. The system 10 includes a server 12 and a plurality of clients 50A-50C operatively connected thereto. As will be further described below, the server 12 is capable of creating, saving, printing and transmitting electronic documents. The clients 50A-50C are capable of receiving electronic documents from the host 12 and displaying such documents for viewing by one or more users. The clients 50A-50C are also capable of receiving information from any of such users that seek to fill out the electronic documents and transmit information back to the host 12.

FIG. 1B shows one embodiment of the host 12 along with one embodiment of a client 50. In this embodiment, the server 12 includes a processor 13, a memory 14, a display 16, one or more input device(s) 18 and one or more communication ports 20a, 20b. The memory 14 is used for storing information and may include one or more computer readable storage media. Example storage media include but are not limited to a floppy disc, a hard-drive, a CD-ROM, a tape backup, a microchip, or any combination thereof. The display 16 is used to display information. Examples display devices include but are not limited to cathode ray tube (CRT) devices, liquid crystal displays (LCD), plasma displays and other video output devices, and devices that produce output on light transmitting films or similar substrates. The input devices 18 provide the capability to entering information. Example types of input devices include but are not limited to a keyboard, mouse, track ball, touchpad, joystick, optical scanner and/or combinations thereof.

The memory 14, display 16, input devices 18 and communication ports 20a, 20b are operatively connect to one another via the processor 13. One of the communication ports 20a is connected to the client 50. The other communication port 20b is connected to the Internet 24.

The client 50 includes a processor 62, a memory 52, a display 54, one or more input device(s) 56 and one or more communication ports 58a, 58b. The client 50 also includes an output device 60 which can be used to export and/or print data, e.g., a printer. Example output devices include but are not limited to printers.

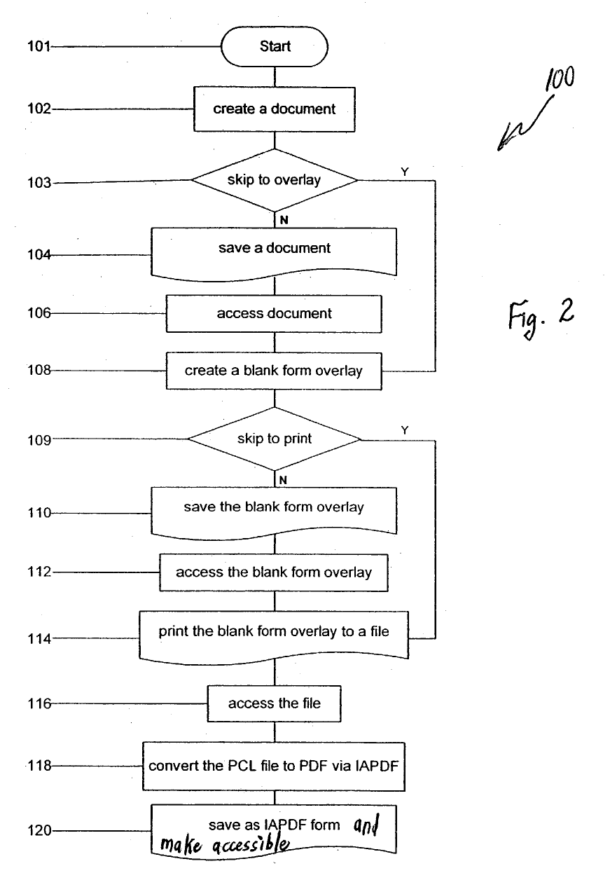

FIG. 2 is a flow diagram 100 showing a process that may be used to generate a PDF document having one or more modifiable fields. The modifiable fields are modifiable when opened with a PDF reader, e.g., Adobe Acrobat Reader™.

At a step 102, an underlying or original electronic document is created in a selected one of a plurality of possible native formats. The native format is typically a function of the software used to create the electronic document, which may be for example but is not limited to, word processing software (e.g., Microsoft Word™ or Word Perfect®), or desktop publishing software (e.g., Adobe PageMaker®, or Microsoft Publisher™). Alternatively, a user may access or retrieve an electronic document that has already been created and stored in an accessible location.

At a step 103, a determination is made as to whether the electronic document is to be saved. If not, execution transitions to a step 108. Otherwise, the document is saved at a step 104. The document may be saved for example, in any storage device and in any format that is thereafter accessible to the server. The saved electronic document may thereafter be accessed at a step 106.

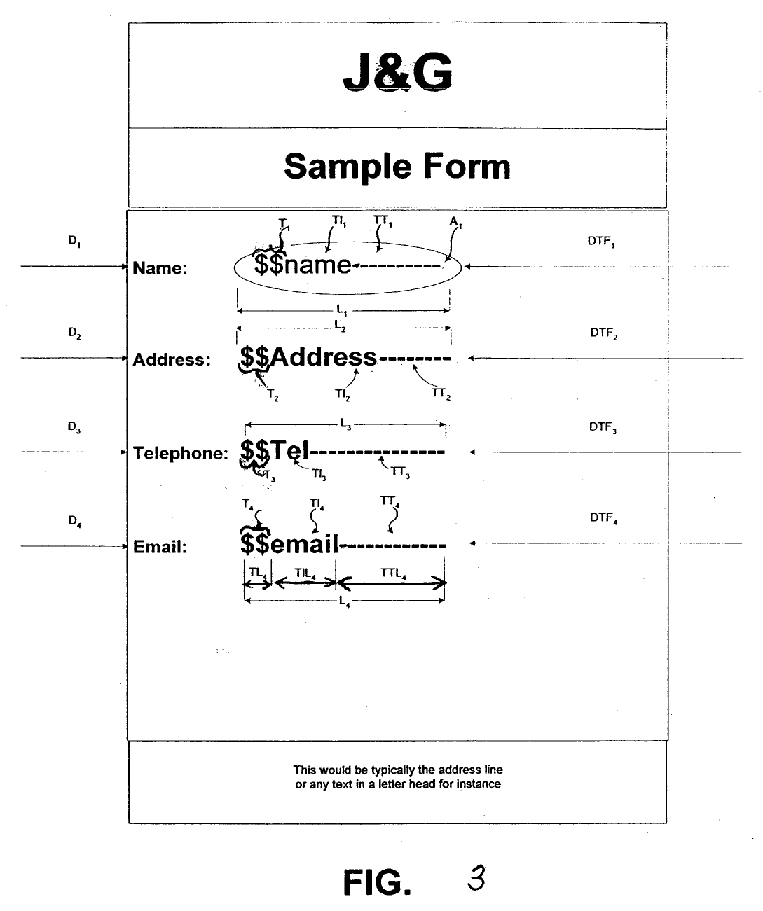

At a step 108, a form overlay template is created by defining at least one data tag field in the electronic document, for example, as illustrated in FIG. 3. As with the electronic document created at step 102, the native form of the form overlay template is a function of the software used to create the form overlay template.

Referring now to FIG. 3, the electronic document includes four locations (e.g., lines) that request or require information. Each of such lines has a label field and a data tag field. In the first of these lines, the label field is filled with the text string “Name:” and the data tag field DTF₁ (i.e., “$$name______”). In the second of these lines, the label field is filled with the text string “Address:” and the data tag field DTF₂ (i.e., “$$Address______”). In the third of these lines, the label field is filled with the text string “Telephone:” and the data tag field DTF₃ (i.e., “$$Tel______”). In the fourth of these lines, the label field is filled with the text string “Email:” and the data tag field DTF₄ (i.e., “$$email______”).

Each of the data tag fields defines an area and position on the underlying electronic document where entry of information is desired. Each data tag field has a tillable area “A”. For example, the data tag field DTF₁ has a fillable area A₁. Each fillable area has a length. For example, the length of the fillable area A₁ for data tag field DTF₁ is designated L₁. The length of the tillable area for data tag field DTF₂ is designated L₂. The length of the fillable area for the data tag field DTF₃ is designated L₃. The length of the fillable area for the data tag field DTF₄ is designated L₄.

In this embodiment, each fillable area includes a tag “T”, a tag identifier “TI”, and a tag trailer “TT”. Thus, for example, the fillable area for data tag field DTF₁ has a tag T₁, a tag identifier TI₁ and a tag trailer TT₁. The fillable area for data tag field DTF₂ has a tag T₂, a tag identifier TI₂ and a tag trailer TT₂. The fillable area for data tag field DTF₃ has a tag T₃, a tag identifier TI₃ and a tag trailer TT₃. The fillable area for data tag field DTF₄ has a tag T₄, a tag identifier TI₄ and a tag trailer TT₄.

Each tag, tag identifier, and tag trailer has a length. For example, the length of the tag T₄ for data tag field DTF₄ is shown as TL₄. The length of the tag identifier TI₄ for data tag field DTF₄ is shown as TIL₄. The length of the tag trailer TT₄ for data tag field DTF₄ is shown as TTL₄

The tags, e.g., T₁-T₄, define the beginning (or starting point) of the respective fillable area. Each tag is shown as being made up of two dollar signs, “$$”. However, other suitable tags may be employed. For example, some other embodiments may employ tags made up of a single dollar sign, more than two dollar signs, and/or some other character(s) altogether.

Each data tag field, DTF₁-DTF₄, has a length (sometimes referred to herein as “DTFL”) that is equal to the summation of the length of the respective tag identifier and tag trailer. Specifically, each tag identifier “TI” has a length “TIL” defined by a description “D”, whereas each tag trailer “TT” has a length “TTL” defined by one or more minus signs “−”, hence, (DTFL=TIL+TTL)

As specifically shown in FIG. 3, a blank form document includes the following description of information “D”: name D1, address D2, telephone D3, and email D4, wherein each description of information “D” can be and is defined as a DTF, which is presently preferably a text field. For example, the DTF1 for the description D1 term “Name” is defined by selecting an area A1 and position P1, via the input device means 62, and then by typing in the “$$name______” characters, using presently preferably a keyboard. Each data tag field, e.g., DTF2-DTF4, may thereafter be defined beginning with the characters “$$”. The quantity of spaces subsequent to the characters “$$” is defined by the respective quantity of the entered character “−”.

Thus, as shown in FIG. 3, the length L1 of the DTF1 area A1 for the term “Name” D1 is defined as permitting thirteen characters which is equal to the tag identifier length TIL1 of four (4) characters in the description term “Name” D1 plus the tag trailer length TTL1 of nine (9) characters defined by the quantity of minus signs (−). Whereas the length DTFL2 of the DTF2 area A2 for the term “Address” D2 is defined as permitting fifteen (15) characters which is equal to the tag identifier length TIL2 of seven (7) characters in the description term “Address” D2 plus the tag trailer length TTL2 of eight (8) characters defined by the quantity of minus signs (−).

Referring again to FIG. 2, at a step 109, a determination is made as to whether the template is to be saved. If not, execution transitions to a step 114. Otherwise, the template is saved at a step 110. The saved form overlay template may be accessed at a step 112.

A step 114 generates a blank form overlay in a printer control format based on the blank form overlay in the native form. This may be carried out, for example, by printing the blank form overlay to a file (e.g., using a print to file command) that resides on a computer readable storage medium. The blank form overlay in printer control format has one or more data tag fields corresponding to the one or more data tag fields defined in the blank form overlay in the native form.

A printer control file is a set of instructions (which may or may not include data) that cause a printer to generate a desired output (or a portion thereof). As will be understood by those of ordinary skill in the art, a printer control file will often be generated with the aid of a printer driver. In some currently preferred embodiments the printer control file is in conformance with one or more PCL (printer control language) formats or standards, e.g., PCL5. PCL formats are currently used in association with numerous commercially available printers including but not limited to HP LaserJet printers, e.g., HP LaserJet 4 printers. In some other currently preferred embodiments the printer control file is in conformance with one or more Post Script standards. It should be recognized that a physical printer may not be needed to generate the printer control file. For example, in at least some embodiments, an appropriate printer driver may be sufficient.

In some currently preferred embodiments, the strings used to identify the data tag fields in the form have a font that the printer driver recognizes as a printer resident font. This helps ensure that the strings are rendered as strings, rather than bit mapped graphics. In some further preferred embodiments, the font is a non proportional font.

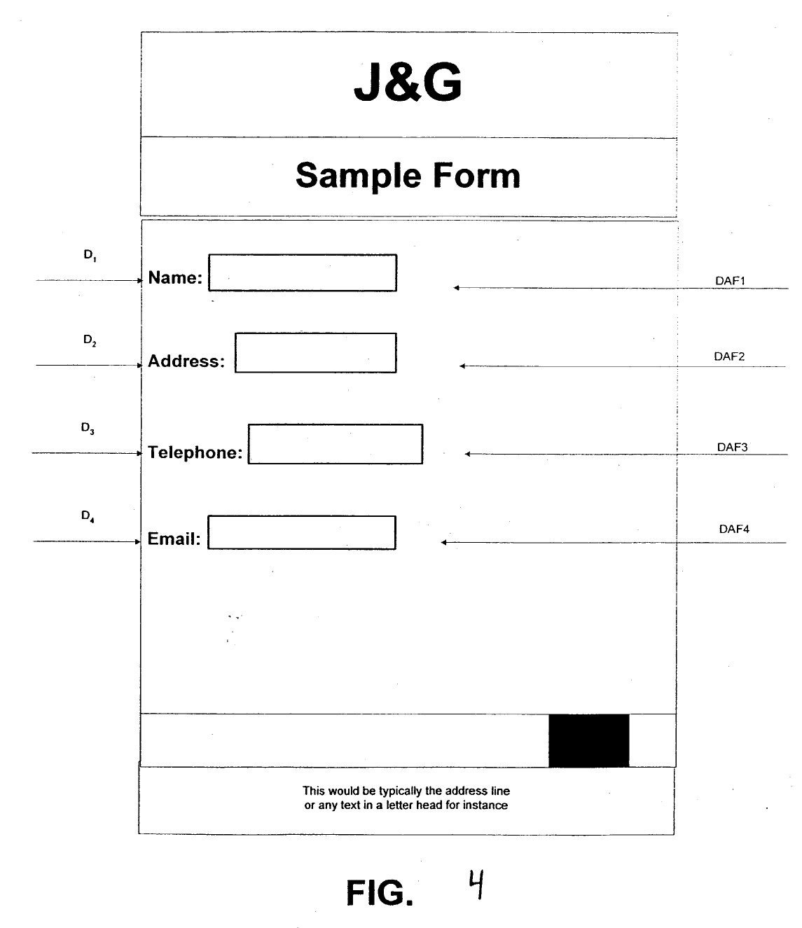

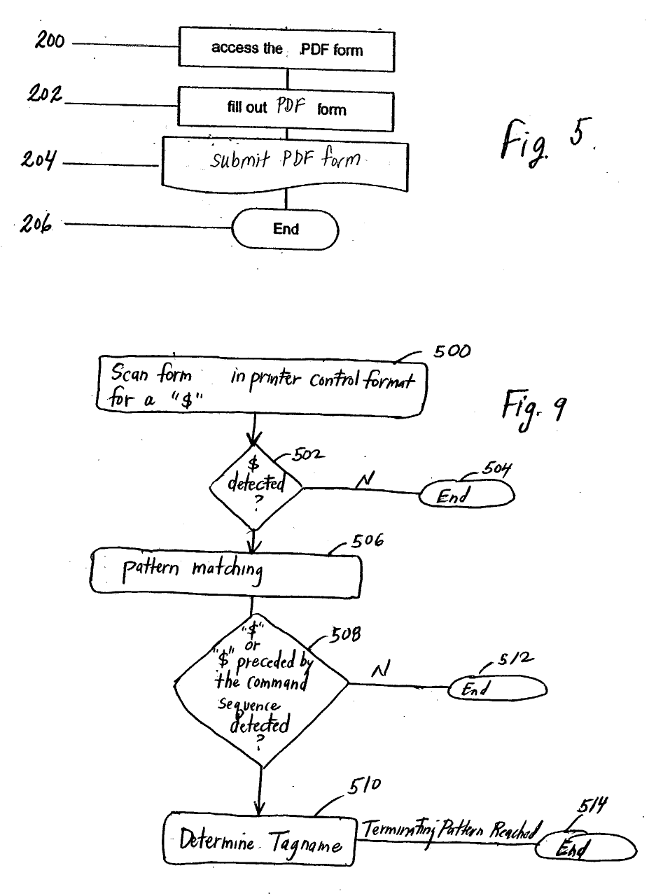

The form overlay in printer control format is sometimes referred to hereinafter as a tagged overlay or tagged printer control file, i.e., a printer control file with at least one data tag field. The file containing the form overlay in printer control format is accessed at a step 116. At a step 118, a PDF document is generated from the form overlay in printer control format. FIG. 4 is a representation of a PDF document generated by one embodiment of the system of FIG. 1 in response to the form overlay in printer control format. Referring to FIG. 4, in this embodiment, each data tag field in the form overlay template of FIG. 3 is converted to a PDF form field in the PDF document of FIG. 4. A PDF form field is a field that is modifiable using a computer program capable of reading and/or displaying a PDF file, for example, but not limited to, Adobe Acrobat Reader™, or Adobe Acrobat™. As will be understood by those of ordinary skill in the art, one type of PDF form field is an acro field. Acro fields are currently used in association with Adobe Acrobat Reader™, and Adobe Acrobat™.

Thus, the PDF document has one or more modifiable fields corresponding to the one or more data tag fields in the tagged printer control file. For example, DTF1 is converted to a corresponding PDF form field DAF1, DTF2 is converted to a corresponding PDF form field DAF2, and so on. This may be carried out, for example, using a computer program IAPDF available from LBM Systems LLC, of New Canaan, Conn.

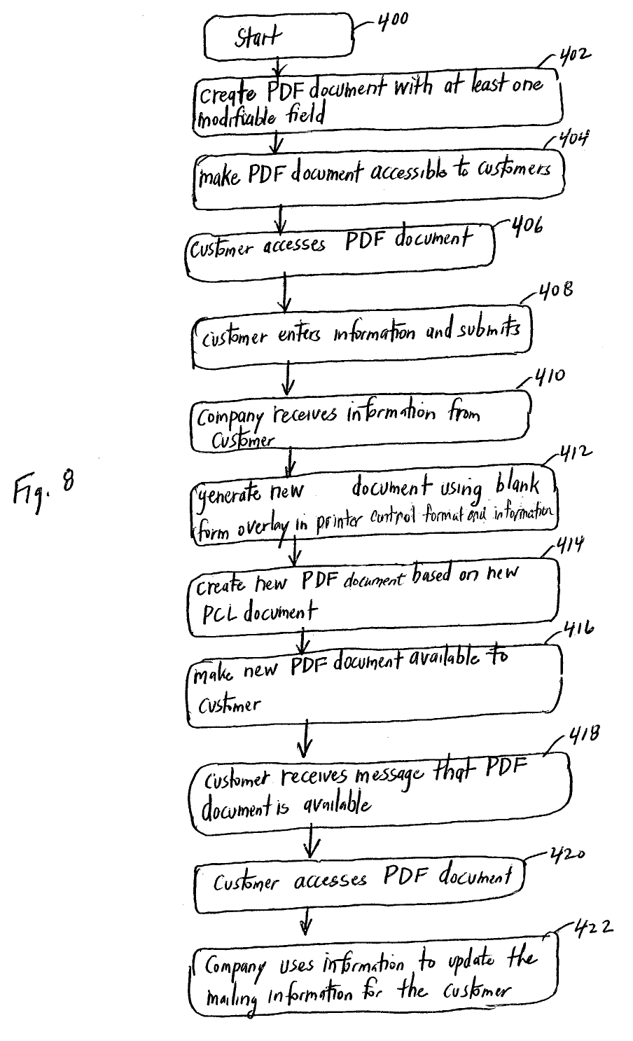

FIG. 9, is a flow chart diagram showing one process for detecting the presence of and/or parsing the data tag field(s) in the blank form shown in FIG. 3. Referring to FIG. 9, a step 500 scans the file having the printer control format, for the presence of a “$” symbol. Thereafter, execution transitions to a step 502. If a “$” has not been detected, then execution transitions to a step 504 and the process ends. If a “$” is detected, then execution transitions to a step 506, which determines whether an optional printer control command sequence is present. In this embodiment, the optional printer control command sequence is: <esc>*p[signed number] [upper or lower-case ‘X’]$. Thereafter, execution transitions to a step 508. If another “$” or a “$” preceded by the printer control command sequence is detected, then execution proceeds to a step 510. Otherwise execution transitions to a step 512 and ends. Step 510 searches for the first letter of the tagname and continues until any of the following patterns are found:

a different PCL pattern, a space or carriage control character, a printable character preceded by a ‘.’, or ‘−’, at which point execution transitions to a step 514 and ends.

It should be understood that although this embodiment uses the delimiter “$$”, the present invention is not limited to this delimiter. Other embodiments may accommodate other delimiters.

Referring again to FIG. 2, at a step 120, the PDF document is saved and made accessible to users on one or more clients. This can be done in any number of ways, including but not limited to by: (1) making the IAPDF form available online (e.g., by posting, or storing, the form in a location made public through a Web Server accessible via the World Wide Web (WWW)), (2) sending the form to users as an email file attachment, (3) storing the form on a local network (e.g., by storing the form as a file in a shared folder within a file system connected to a local network, or combinations thereof.

FIG. 5 is a flowchart illustrating an example of a process in which the PDF document of FIG. 4 is used to obtain information from a user. Referring to FIG. 5, at a step 200, if the form is available online, then the user may access the form via a web browser (e.g., MS Internet Explorer or Netscape) on one of the clients 50A-50C on which a PDF reader plug-in (e.g., an Adobe Acrobat Reader plug-in) has been installed. This plug-in enables the web browser on the client to open the PDF document and display the PDF document within the window of the Web Browser (as if it were displaying a graphic or a video). The plug-in also provides the user with the capability to enter information into the PDF form fields within the PDF document and submit the PDF document (i.e., the information in the document).

At a step 202, the user “fills out” the PFD form by selectively entering data, via an input device, in the at least one PDF form field. For example, as illustrated in FIG. 4, the sample form has four PDF form fields, specifically the name PDF form field DAF1, address PDF form field DAF2, telephone PDF form field DAF3, and email PDF form field DAF4. Thus, in some embodiments, a user on the client computer 50 would point and click in one or more of the PDF form fields, and thereafter enter the relevant data therein, such as, for example, by typing and/or, pasting via the input device 56 illustrated in FIG. 1B.

It should be understood that the Adobe Acrobat Reader™ plug-in does not enable the user to save the PDF form with the information entered into acro fields. Doing so would require the full version of Adobe Acrobat™. Indeed, if a user tried to save the PDF form without the full version of Adobe Acrobat™, only the blank PDF form would be saved.

After the user has entered information into the form, that information can be submitted at a step 204. Submitting the information may be carried out in any number of ways. In some embodiments, the PDF form is provided with a submit button that initiates a POST process similar to the process used to submit HTML forms. In particular, clicking on the submit button causes the information in the PDF form fields to be stored in a temporary file with one of three different formats: FDF, HTML, or XML. The temporary file is then sent via a POST method to a uniform resource locator (URL), for example, http://www.myweb.com/someapp.asp or http://www.myweb.com/someapp.php. It should be understood however, that the information may be sent back to the publisher's web site or to any other web site or destination designed to receive and/or process the information.

If the temporary file is delivered to a web server, the server may include a program designed to receive the information being submitted to the URL. This program is sometimes referred to as a script or a script application. As is known to those of ordinary skill in the art, a script is written in a language that runs on the Web Server on which it resides. The script for a IIS Web Server is ASP (Active Server Pages). The script for a Tomcat Web Server is PHP (Hypertext Preprocessor). The script receives the data and performs desired processing. The processing may include, for example, but is not limited to: reformatting the data to populate a data base, validating data, saving data in temporary file on the server, using data as a trigger for an alternate process to start, or any combination thereof.

In some embodiments the script uses the information from the customer to generate a new PDF document, which may be made available to the customer.

FIG. 6 is a flowchart illustrating one embodiment for generating a new PDF document based upon the form overlay in printer control format and information supplied by the user. At a step 300, the data is reformatted and a tag file is created. At a step 302, a filled in form in printer control format is generated based on the tag file and the file containing the original form in printer control format (i.e., the tagged overlay). This may be carried out for example by using Forms&Fonts available from LBM Systems LLC, of New Canaan, Conn. At a step 304, the filled in form in printer control format is then converted to a PDF format, for example, using IAPDF available from LBM Systems LLC, of New Canaan, Conn. At a step 306, the PDF format document is made available to the customer, e.g., via email, internet server shared location, etc. The customer may display this document using Adobe Acrobat Reader or a Web Browser that has the Adobe Reader plug-in installed. The customer can save this document on a storage device.

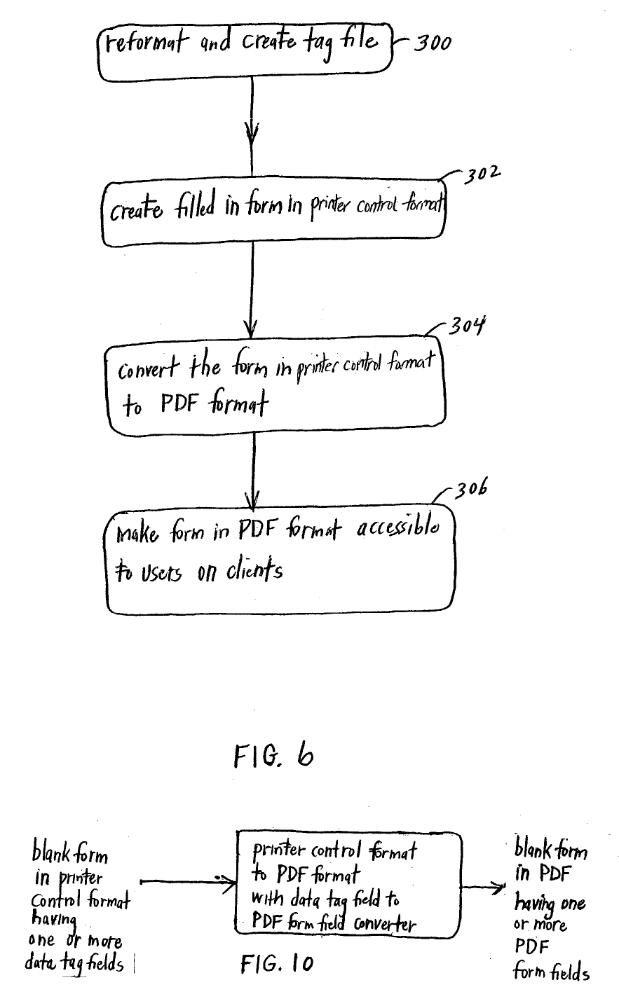

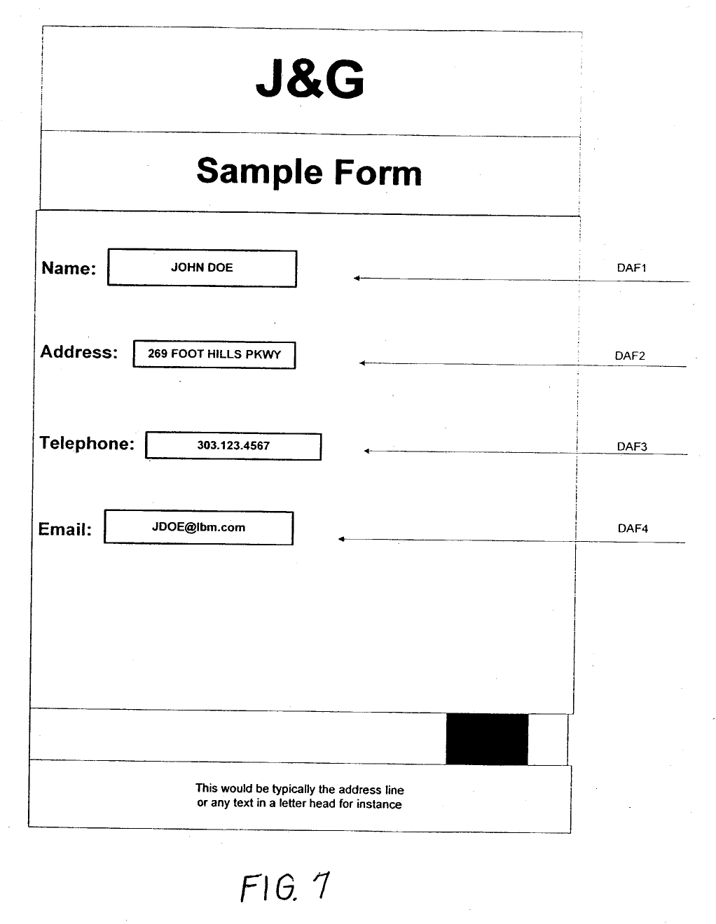

FIG. 7 is a representation of an electronic document that includes the information supplied by a user.

FIG. 8 is a flowchart illustrating the use of the above process in an embodiment in which a company desires updated mailing information for customers. At a step 400, a company decides that there is a need to update mailing information for their customers. At a step 402, the company creates a PDF document with at least one modifiable field using the process shown and described with respect to FIG. 2. At a step 404, the company posts the PDF form and/or sends a mailing list to all (or at least one) of their customers asking them to fill in the form and submit the information. At a step 406, a customer accesses the PDF document by going to a link or opening an email attachment. At a step 408, the customer enters information in the form and submits the information by clicking on a submit button located on PDF form. The customer does NOT have the ability to save the filled form at this point (unless he has the Adobe Acrobat full version). At a step 410, the company receives and processes the information entered by the customer. This may be carried out, for example, by a script application that resides on a Web Server. There is no requirement that the Web Server be the same server as that on which the PDF form was originated (if the PDF form had in fact been originated on a server). Nor is there any requirement that the Web Server be the same server where the PDF is posted (if it is in fact posted). At a step 412, the script application uses the form overlay in printer control format and the information from the customer to generate a new printer control document. Forms&Fonts software available from LBM Systems LLC, of New Canaan may be used to generate the new printer control document.

At a step 414, the script application creates a new PDF document, e.g., using the IAPDF program. At a step 416, the script application makes the new PDF document available to the customer. For example, the PDF document may be stored in a public location, e.g., a directory on a Web Server, and the customer may be provided with a link to the new document. At a step 418, the customer (who may be waiting for something to happen after submitting the data to the company) receives a message (e.g., on his web browser) that the user can use to obtain a copy of the completed form. For example the customer may receive a message (e.g., on his web browser) that includes a link to the completed form. At a step 420, the customer activates (e.g., clicks on) the link, causing the new read-only document to displayed. If desired, the customer may then save the document on a customer storage device. At a step 422, the script application reformats the customer data, accesses the customer record in the company customer data base, and updates the mailing information.

It should be understood that in a currently preferred embodiment, the server 12 includes means for creating a form overlay template. Where the form overlay template is accessed depends on which computer readable storage medium stored the form overlay template. A currently preferred embodiment further includes means for printing the form overlay template to a file, on a memory wherein the format of the form overlay is changed from its selected one of a plurality of native formats to a printer control format. For example, rather than saving the form overlay template to a file, typically, most if not all software, including word processing software(s) as those set forth above, provide an option to print to file. As such, the act of printing 114 the form overlay template to the memory generates the form overlay in printer control format.

It should also be understood that in one currently preferred embodiment, the server 12 further includes means for generating and accessing a form overlay in PCL type printer control format. In such currently preferred embodiment, the server additionally includes means for generating a PDF document in response to the form overlay in PCL type printer control format. In one of these currently preferred embodiments, this is carried out using a computer program IA-PDF (“Interactive PDF”) available from LBM Systems LLC, of New Canaan, Conn. In a currently preferred embodiment, IA-PDF is built upon a computer program Pcl2pdf available from Visual Software of Dorking, United Kingdom. Pcl2pdf reads, parses and interprets PCL files (e.g., Laser Jet PCL print files) to generate Acrobat PDF document format output. IA-PDF provides interactive forms filling capability by incorporating tags or markers within the PCL print files (e.g., Laser Jet PCL print files). The tags are read and interpreted and corresponding interactive forms field definitions are provided with the PDF document (e.g., an Acrobat PDF document output). The PDF documents can then be viewed using the PDF reader software (e.g., Adobe Acrobat software) product range for on-line filling and completion by end-users. Likewise, it should be understood that in a currently preferred embodiment, the clients 50A-50C include means for accessing data stored at a location accessible from the Internet 24 via the second communication device 20b, for example, a modem or other similar storage device in existence now or developed in the future. In such manner, data may be retrieved from a specific location via the Internet 24, by downloading files/documents/data or requesting files/documents/data be sent via email in various formats, e.g., word processing format, PCL format, non-PDF format. In addition, files/documents/data may be uploaded from a floppy disk, a hard-drive, a CD, a tape backup, and/or a chip or any other conventional storage medium or combination thereof. It should also be understood that in the currently preferred embodiment, the clients further include means for filling out the PDF form by selectively entering data in at least one PDF form field, such that as far as the user is concerned, the form appears to be completed.

Notwithstanding the above, it should be recognized that although the server 12 is capable of creating, saving, printing and transmitting electronic documents, some servers may lack one or more of these capabilities and/or may have capabilities other than these capabilities. It should also be recognized that some clients may lack one or more of the capabilities of the clients 50A-50C and/or may have capabilities other than their capabilities. Moreover, although one or more of the embodiments described herein makes use of Adobe Acrobat reader, it should be understood that the present invention is not limited to such. Any PDF format software may be used.

It should be understood that a processor may be any kind of processor. For example, the processor may be programmable or non programmable, general purpose or special purpose, dedicated or non dedicated, distributed or non distributed, shared or not shared, and/or any combination thereof. A processor may comprise hardware, software, firmware, hardwired circuits and/or any combination thereof. The processor may or may not execute one or more computer programs that have one or more subroutines, or modules, each of which may include a plurality of instructions, and may or may not perform tasks in addition to those described herein. If the computer program includes more than one module, the modules may be parts of one computer program, or may be parts of separate computer programs. It should be recognized, that as used herein, the term module is not limited to a subroutine but rather may for example comprise hardware, software, firmware, hardwired circuits and/or any combination thereof.

In some embodiments, the processor comprises at least one processing unit connected to a memory system via an interconnection mechanism (e.g., a data bus). A memory system may include a computer-readable and writeable recording medium. The medium may or may not be non-volatile. Examples of non-volatile medium include a magnetic disk, flash memory, and magnetic tape. A disk may be removable, e.g., known as a floppy disk, or permanent, e.g., known as a hard drive. Examples of volatile memory include but is not limited to random access memory, e.g., dynamic random access memory (DRAM) or static random access memory (SRAM), which may or may not be of a type that uses one or more integrated circuits to store information. A variety of mechanisms are known for managing information movement between a disk and an integrated circuit memory element.

If the processor executes one or more computer programs, the one or more computer programs may be implemented as a computer program product tangibly embodied in a machine-readable storage medium or device for execution by a compute. Further, if the processor is a computer, such computer is not limited to a particular computer platform, particular processor, or programming language. Computer programming languages may include but are not limited to procedural programming languages, object oriented programming languages, and combinations thereof.

A general purpose computer system may or may not execute a program called an operating system, which may or may not control the execution of other computer programs and provides scheduling, debugging, input/output control, accounting, compilation, storage assignment, data management, communication control, and/or related services. A general purpose computer system may for example be programmable using a computer language such as C, C++, Java or other language, such as a scripting language or even assembly language. The computer system may also be specially programmed, special purpose hardware, or an application specific integrated circuit (ASIC).

As stated above, the communication link may be any kind of communication link including but not limited to, for example, wired (e.g., conductors, fiber optic cables) or wireless (e.g., microwave links, satellite links, infrared links), and combinations thereof, each of which may be public or private, dedicated and/or shared (e.g., a network). The communication link may employ for example circuit switching or packet switching or combinations thereof. Other examples of communication links include dedicated point-to-point systems, wired networks, and cellular telephone systems. The communication link may employ any protocol or combination of protocols including but not limited to the Internet Protocol.

Although mouse and keyboard input devices are shown, other types of input devices including but not limited to, tactile input devices such as a touch screens, may be employed.

Examples of output devices include but are not limited to cathode ray tube (CRT) devices, liquid crystal displays (LCD), plasma displays and other video output devices, printers, communication devices for example modems, storage devices such as a disk or tape and audio output, and devices that produce output on light transmitting films or similar substrates.

Although a display and printer output devices are shown, other types of output devices may be employed. Example input devices include but are not limited to keyboards, keypads, track ball, mouse, pen and tablet, light pen, touch screens, and data input devices such as audio and video capture devices. It should thus be understood that the present invention is not limited to the input or output devices described herein.

It should be understood there the present invention is not limited to the forms shown above. There are many different types of forms and/or form layouts. For example, although the forms in FIGS. 3, 4 and 7 request a name, address, telephone number and email address, forms can request any type of information. In addition, although FIGS. 3, 4 and 7 show forms in which a label field and a corresponding data field are located on the same line, this is not required. For example, in some other embodiments, a label field may be located in an area that is above, below, and/or diagonal from, a corresponding data tag field. Furthermore, it should be recognized that forms may provide information in addition to requesting information.

Although some of the embodiments above include data tag fields having a particular format, it should be understood that the data tag field can have any format.

It should be recognized that there are many ways that a form can be converted from a first format to a second format. For example, in some embodiments, the form is actually modified from the first format so that it conforms to the second format. In some other embodiments, the form itself is not actually modified. Instead, a second form is generated, the second form having the second having the format. In the latter embodiments, the form having the first format remains intact, unless it is modified or deleted for some other reason.

Note that, except where otherwise stated, terms such as, for example, “comprises”, “has”, “includes”, and all forms thereof, are considered open-ended, so as not to preclude additional elements and/or features.

Also note that, except where otherwise stated, terms such as, for example, “in response to” and “based on” mean “in response at least to” and “based at least on”, respectively, so as not to preclude being responsive to and/or based on, more than one thing.

While the disclosure has been described with respect to presently preferred representative embodiments, those skilled in the art will readily appreciate that various changes and/or modifications can be made to the disclosure without departing from the spirit or scope of the disclosure as defined by the appended claims.

What is claimed is:

1. A computer implemented method comprising:
providing a form overlay in a printer control format, the form overlay having at least one data tag field; and
generating a PDF form in response to the form overlay, wherein the PDF form includes at least one PDF form field that is generated in response to the at least one data tag field of the form overlay.

2. The computer implemented method of claim 1 wherein each of the at least one PDF form field is generated in response to a uniquely associated one of the at least one data tag field of the form overlay.

3. The computer implemented method of claim 1 wherein each of the at least one PDF form field is uniquely mapped into a uniquely associated one of the at least one data tag field of the form overlay.

4. The computer implemented method of claim 1 wherein the printer control format comprises a PCL format.

5. The computer implemented method of claim 1 wherein the printer control format comprises a Post Script format.

6. The computer implemented method of claim 1 wherein the PDF form field comprises a data acro field.

7. The computer implemented method of claim 1 wherein generating the PDF form further comprises generating a field which upon activation initiates submission of the PDF form.

8. The computer implemented method of claim 1 further comprising:
receiving data;
generating a merged form in response to the data and a form overlay in printer control format.

9. The computer implemented method of claim 8 wherein receiving data comprises receiving the data over the Internet.

10. A computer program product comprising:
a computer readable storage medium;
a computer program, stored on the computer readable storage medium, wherein the computer program, when executed by a computer, direct the computer to perform a method comprising:
providing a form overlay in a printer control format, the form overlay having at least one data tag field; and
generating a PDF form in response to the form overlay, wherein the PDF form includes at least one PDF form field that is generated in response to the at least one data tag field of the form overlay.

11. A system comprising:
means for receiving a form overlay in a printer control format, the form overlay having at least one data tag field; and
means for generating a PDF form in response to the form overlay, wherein the PDF form includes at least one PDF form field that is generated in response to the at least one data tag field of the form overlay.

12. A system comprising:
a processor for providing a form overlay in a printer control format, the form overlay having at least one data tag field, and for generating a PDF form in response to the form overlay, wherein the PDF form includes at least one PDF form field that is generated in response to the at least one data tag field of the form overlay.

13. A method for universally modifying an electronic document comprising the acts of:
creating an underlying electronic document having a selected one of a plurality of native formats;
creating a blank form overlay, having a selected one of a plurality of native formats, based on the underlying electronic document by defining at least one data tag field;
printing the blank form overlay to a file, on the computer readable storage medium, such that the act of printing causes the format of the blank form overlay to change from its selected one of a plurality of native formats to a PCL format;
accessing the blank form overlay in PCL format on the computer readable storage medium;
converting the format of the blank form overlay from PCL to IAPDF, such that each data tag field is converted to a data acro field;
filling out the blank form overlay, by selectively adding data in the at least one data acro field, such that a completed electronic form is created;
submitting the completed electronic form in a IAPDF format to the computer readable storage medium; and
processing the completed electronic form on the computer readable storage medium via a script.

14. The method of claim 13, wherein the native format is selected from the group comprising:
only textual, only graphical, and a combination of textual and graphical formats.

15. The method of claim 13, wherein each act of creating is selectively performed from the group comprising:
a word processing program, or a desktop publishing program.

16. The method of claim 15, wherein the word processing program is selected from the group comprising:
Microsoft Word™, and WordPerfect®.

17. The method of claim 15, wherein the desktop publishing program is selected from the group comprising:
Adobe PageMaker®, and Microsoft Publisher™.

18. The method of claim 13, wherein each data tag field has a fillable area comprising:
a length defined by a tag, a tag identifier, and a tag trailer.

19. The method of claim 17, wherein each tag has a length defined by at least one dollar sign “$”.

20. The method of claim 19, wherein the tag has a length defined by the quantity of dollar sign “$”.

21. The method of claim 19, wherein each tag is defined by two dollar signs “$$”

22. The method of claim 18, wherein each tag identifier has a length defined by a description.

23. The method of claim 18, wherein each tag identifier is converted to a PDF form field identifier having a length equal to the length of the tag identifier.

24. The method of claim 18, wherein each tag trailer has a length defined by at least one minus (−) sign.

25. The method of claim 24, wherein the tag trailer has a length defined by the quantity of minus “−” signs.

26. The method of claim 23, wherein the length of the PDF form identifier field is determined by the combined length of the tag identifier and the tag trailer.

27. The method of claim 13, wherein each data tag field is a text field.

28. The method of claim 13, wherein in the act of accessing the blank form overlay includes receipt by email.

29. The method of claim 13, wherein the act of accessing the blank form overlay includes downloading over a modem.

30. The method of claim 13, wherein the act of saving the completed electronic form includes saving to a local computer readable storage medium.

31. The method of claim 14, further including the act of:
saving by transmitting the completed electronic form by clicking on an icon via an input device, such that the act of saving sends the completed electronic form to a URL as a FDF; and
storing the FDF data upon receipt thereof, on a computer readable storage medium.

32. A method for universally modifying an electronic document comprising the acts of:
creating an underlying electronic document having a selected one of a plurality of native formats;
saving the underlying electronic document in its selected one of a plurality of native formats to a computer readable storage medium;
accessing the underlying electronic document in its selected one of a plurality of native formats from the computer readable storage medium;
creating a blank form overlay, having a selected one of a plurality of native formats, based on the underlying electronic document by defining at least one data tag field;
saving the blank form overlay in a selected one of a plurality native formats to the computer readable storage medium;
accessing the blank form overlay in its selected one of a plurality of native format from the computer readable storage medium;
printing the blank form overlay to a file, on the computer readable storage medium, such that the act of printing causes the format of the blank form overlay to change from its selected one of plurality of native formats to a PCL format;
accessing the blank form overlay in PCL format on the computer readable storage medium;
converting the format of the blank form overlay from PCL to IAPDF, such that each data tag field is converted to a data acro field;
saving the blank form overlay in IAPDF format to the computer readable storage medium;
accessing the blank form overlay in IAPDF format on the computer readable storage medium;
filling out the blank form overlay, by selectively adding data via an input device in the at least one data acro field, such that a completed electronic form is created;
submitting the completed electronic form in a IAPDF format to the computer readable storage medium; and
processing the completed electronic form on the computer readable storage medium via a script thereon.

33. A computer implemented method for responding to information submitted from a client to an intranet or internet server, the information being indicative of data entered into one or more PDF form fields of a PDF document, the method comprising:
receiving the information submitted from the client;
generating a data file having at least one data field in response to the information;
generating a merged form in response to the data file and a form overlay in printer control format, the form overlay having at least one data tag field; and
generating a PDF document in response to the merged form.

34. The computer implemented method of claim 33 wherein generating a merged form comprises mapping data from at least one data field in the data file into at least data field in the merged form.

35. The computer implemented method of claim 33 wherein generating a merged form comprises mapping data from each of the at least one data field in the data file into a uniquely associated one of at least one data tag field in the merged form.

36. The computer implemented method of claim 33 wherein the printer control format comprises a PCL format.

37. The computer implemented method of claim 33 further comprising making the PDF file accessible to at least one client.

38. The computer implemented method of claim 33 further comprising supplying the PDF file to at least one client.

39. A computer program product comprising:
a computer readable storage medium;
a computer program, stored on the computer readable storage medium, wherein the computer program, when executed by a computer, direct the computer to perform a method comprising:
receiving the information submitted from the client;
generating a data file having at least one data field in response to the information;
generating a merged form in response to the data file and a form overlay in printer control format, the form overlay having at least one data tag field; and
generating a PDF document in response to the merged form.

40. A system for responding to information submitted from a client to an intranet or internet server, the information being indicative of data entered into one or more PDF form fields of a PDF document, the system comprising:
means for receiving the information submitted from the client;
means for generating a data file having at least one data field in response to the information;
means generating a merged form in response to the data file and a form overlay in printer control format, the form overlay having at least one data tag field; and
means for generating a PDF document in response to the merged form.

41. A system for responding to information submitted from a client to an intranet or internet server, the information being indicative of data entered into one or more PDF form fields of a PDF document, the system comprising:
a processor for receiving the information submitted from the client, generating a data file having at least one data field in response to the information, generating a merged form in response to the data file and a form overlay in printer control format, the form overlay having at least one data tag field; and generating a PDF document in response to the merged form.
